(19) United States
(12) Patent Application Publication
(10) Pub. No.: US 2017/0268597 A1
(43) Pub. Date: Sep. 21, 2017

(54) Rotary Vibration Damping Arrangement For The Drivetrain Of A Vehicle

(71) Applicant: ZF FRIEDRICHSHAFEN AG, Friedrichshafen (DE)

(72) Inventors: Tobias HÖCHE, Hofheim i. UFr. (DE); Daniel LORENZ, Bad Kissingen (DE); Ingrid HOFFELNER, Knetzgau (DE)

(21) Appl. No.: 15/503,655

(22) PCT Filed: Jul. 13, 2015
(86) PCT No.: PCT/EP2015/065919

§ 371 Date: Feb. 13, 2017

(30) Foreign Application Priority Data
Aug. 13, 2014 (DE) 10 2014 216 072.3

(51) Int. Cl. F16F 15/12; F16H 57/08; F16F 15/123

(52) U.S. Cl. CPC F16F 15/1206; F16F 15/12353; F16H 57/082

(57) ABSTRACT

A torsional vibration damping arrangement has an input region with a primary mass driven in rotation around an axis of rotation, and an output region. A first and a second parallel torque transmission paths (48), and a coupling arrangement having a planetary gear unit with a planet wheel element for superimposing the torques guided via the torque transmission paths are provided between the input region and the output region. A phase shifter arrangement with a first stiffness is provided in the first torque transmission path for generating a phase shift of rotational irregularities relative to rotational irregularities guided via the second torque transmission path. The phase shifter arrangement has a second stiffness supported on the one hand relative to the primary mass arranged so as to be at least partially axially and radially overlapping with respect to the planet wheel element.

### CROSS REFERENCE TO RELATED APPLICATIONS

This is a U.S. national stage of application No. PCT/EP2015/065919, filed on Jul. 13, 2015. Priority is claimed on German DE102014216072.3, filed Aug. 13, 2014, the content of which is incorporated here by reference.

### BACKGROUND OF THE INVENTION

1. Field of the Invention

The present invention is directed to a torsional vibration damping arrangement for the powertrain of a vehicle, comprising an input region to be driven in rotation around an axis of rotation and an output region, there being provided between the input region and the output region a first torque transmission path and, parallel thereto, a second torque transmission path and a coupling arrangement for superimposing the torques guided via the torque transmission paths, wherein a phase shifter arrangement is provided in the first torque transmission path for generating a phase shift of rotational irregularities guided via the first torque transmission path relative to rotational irregularities guided via the second torque transmission path.

2. Description of Prior Art

A generic torsional vibration damping arrangement known from German patent application DE 10 2011 007 118 A1 divides the torque introduced into an input region, for example, through a crankshaft of a drive unit, into a torque component transmitted via a first torque transmission path and a torque component guided via a second torque transmission path. Not only is there a static torque divided with this torque division, but also the vibrations and rotational irregularities which are generated, for example, by the periodically occurring ignitions in a drive unit contained in the torque to be transmitted are also divided proportionately into the two torque transmission paths. The torque components transmitted via the two torque transmission paths are brought together again in a coupling arrangement constructed as planetary gear unit with a planet wheel, an input element and an output element and are then introduced as total torque into the output region, for example, a friction clutch or the like.

A phase shifter arrangement constructed in the manner of a vibration damper, i.e., with a primary side and a secondary side, which is rotatable with respect to the primary side through the compressibility of a spring arrangement, is provided in at least one of the torque transmission paths. In particular when this vibration system passes into a supercritical state, i.e., when it is excited by vibrations exceeding the resonant frequency of the vibration system, a phase shift of up to 180° occurs. This means that at maximum phase displacement the vibration components proceeding from the vibration system are shifted in phase by 180° with respect to the vibration components received by the vibration system. Since the vibration components guided via the other torque transmission path do not undergo a phase shift or, if so, a different phase shift, the vibration components contained in the unified torque components are then shifted in phase with respect to one another and are destructively superimposed on one another such that, ideally, the total torque introduced into the output region is a static torque which contains essentially no vibration components.

### SUMMARY OF THE INVENTION

Proceeding from the background art cited above, it is an object of one aspect of the present invention to develop a torsional vibration damping arrangement which has a further improved vibration damping behavior and which is compact in addition.

According to one aspect of the invention, a torsional vibration damping arrangement for the powertrain of a motor vehicle comprises an input region to be driven in rotation around a rotational axis (A) and an output region, the input region comprising a primary mass and the output region comprising a secondary mass, and a coupling arrangement that communicates with the output region, the coupling arrangement comprising a first input element, a second input element and an output element, and a torque transmission path for transmitting a total torque, which torque transmission path extends between the input region and the output region, wherein the torque transmission path from the input region to the coupling arrangement is divided into a first torque transmission path for transmitting a first torque component and a parallel, second torque transmission path for transmitting a second torque component, wherein the first torque transmission path, the second torque transmission path and, therefore, the first torque component and the second torque component are guided together again at the coupling arrangement to form an output torque, and a phase shifter arrangement in the first torque transmission path comprising a vibration system with a first stiffness, wherein the first stiffness comprises a spring arrangement, and wherein an input torsional vibration proceeding from the input region is divided into a first torsional vibration component and a second torsional vibration component by being guided via the first torque transmission path and via the second torque transmission path, and wherein during an operation of the vibration system in a speed range above at least one limit speed at which the vibration system is operated in a resonant range, the first torsional vibration component and the second torsional vibration component are superposed at the coupling arrangement such that the first torsional vibration component and the second torsional vibration component are destructively superposed, and an output torsional vibration which is minimized relative to the input torsional vibration is accordingly present at the output element of the coupling arrangement, wherein the phase shifter arrangement comprises a second stiffness which is supported on the one hand relative to the primary mass and is arranged so as to be at least partially axially and radially overlapping with respect to the planet wheel element. The arrangement of the second stiffness, which can advantageously comprise a spring arrangement, for example, a nested or non-nested helical spring arrangement, and a bow spring arrangement in the region of the planetary gear unit, is particularly advantageous with respect to an optimal utilization of installation space, since there is free installation space between the planet wheels viewed in circumferential direction. This free installation space is determined depending on the quantity of planet wheels used. The maximum spring work that can be achieved can be increased through the use of a second stiffness. Since the installation space between the planet wheels is limited, it is advantageous that the stiffness of the second stiffness between the planet wheels is selected so as to be greater, and the first stiffness is configured to be softer.

The torque path and, therefore, also the transmission path of the torsional vibrations which are engendered especially by the drive unit, for example, a reciprocating piston engine, run in the following manner: Proceeding from the input region, a total torque is divided into the first torque transmission path and the second transmission path. The phase shifter arrangement comprising at least the first stiffness and the second stiffness is located in the first torque transmission path. Since the second stiffness is arranged so as to be at least partially axially overlapping with respect to the planetary gear unit and, in so doing, also at least partially radially overlapping between the planet wheels, a possible twist angle of the second stiffness is limited. For this reason, it is advantageous to configure the first stiffness to be softer. As a result, the torque path in the first torque transmission path also first runs via the second stiffness and thereafter via the first stiffness at the first input element, advantageously an input ring gear, of the coupling arrangement, in this case, advantageously the planetary gear unit. In the second torque transmission path, the transmitted torque component is rigidly and, therefore, directly guided to the second input element of the coupling arrangement. The torque components and, therefore, also the respective torsional vibration components are destructively superposed at the coupling arrangement such that an output torsional vibration at the output element of the coupling arrangement is minimized, optimally even completely extinguished, relative to the input torsional vibration.

In an advantageous configuration, the coupling arrangement comprises a planetary gear unit with a planet wheel carrier, a planet wheel pin fastened to the planet wheel carrier, and a planet wheel element rotatably supported at the planet wheel pin, wherein the planet wheel element is connected to the input region by the first input element and by the second input element, and wherein the planet wheel element is connected to the output region by the output element.

In so doing, the first torque component and the first torsional vibration component are guided to the planet wheel element of the coupling arrangement via the first torque transmission path by the first input element, whereas the second input element guides the second torque component and the second torsional vibration component rigidly to the planet wheel element by the second torque transmission path. The first torque component and the second torque component and the first torsional vibration component and the second torsional vibration component are guided together again or, more precisely, superimposed, at the planet wheel element and conveyed to the output element as output torque and as output torsional vibration. In an advantageous embodiment, the output element can receive a friction clutch, for example.

The first input element is connected in its operative direction to the phase shifter arrangement on the one side and to the planet wheel element on the other side. The second input part is connected in its operative direction to the input region on the one side and to the planet wheel element on the other side. The superposition unit in turn is connected in its operative direction to both the first input part and the second input part on the one side and to the output part on the other side. The output part forms the output region and can receive a friction clutch in an advantageous embodiment.

In order to achieve the phase shift in a simple manner in one of the torque transmission paths, it is suggested that the phase shifter arrangement comprises a vibration system with a primary mass and an intermediate element which is rotatable with respect to the primary mass around the axis of rotation A against the action of a spring arrangement. A vibration system of this type can be constructed as a kind of vibration damper, known per se, in which the resonant frequency of the vibration system can be adjusted in a defined manner, particularly by influencing the primary-side mass and secondary-side mass as well as the stiffness of the spring arrangement, and the frequency at which there is a transition to the supercritical state can accordingly also be determined.

A further advantageous embodiment form provides that the second stiffness is supported on the other side relative to the intermediate element. The intermediate element can advantageously be connected to the input ring gear so as to be fixed with respect to rotation relative to it. In addition, a mass of the intermediate element serves to adjust the phase shifting.

An additional mass, a pendulum mass and a centrifugal force-dependent tuned mass damper can also be fastened to the intermediate mass, for example.

In a further advantageous configuration, the phase shifter arrangement comprises an additional stiffness arranged so as to be at least partially axially overlapping with respect to the first stiffness. The additional stiffness can also comprise a spring element such as a helical spring or a bow spring, for example. Through the use of the third stiffness, which is advantageously arranged in series with the first stiffness and second stiffness, a greater spring work and a greater twist angle can be achieved between the primary mass and the secondary mass, which can have an advantageous effect on the vibration damping behavior.

A further advantageous embodiment form provides that the first stiffness and the second stiffness of the phase shifter arrangement are arranged in series with one another. As has already been mentioned, a greater spring work and a larger twist angle between the primary mass and the secondary mass can be achieved by the series arrangement, which can have an advantageous effect on the vibration damping behavior.

In a further advantageous embodiment form, the first stiffness, second stiffness and additional stiffness of the phase shifter arrangement are arranged in series with one another. As has already been mentioned, this brings about a greater spring work and a larger twist angle between the primary mass and the secondary mass, which can have an advantageous effect on the vibration damping behavior. More than three stiffnesses can also be used, all of which are likewise advantageously arranged in series.

A further advantageous configuration provides that the second torque transmission path between the input region and the second input element of the coupling arrangement comprises an additional stiffness. This can advantageously influence the tuning of the torsional vibration damping arrangement. In an advantageous embodiment form, the stiffness is constructed as a helical compression spring which is formed of one part or also preferably formed of a plurality of parts nested radially one inside the other and so as to be virtually free of friction.

In a further advantageous embodiment form, the torque transmission path between the output part of the coupling arrangement and the output region comprises at least one first output stiffness. This is particularly advantageous in order to further reduce any output torsional vibrations still present downstream of the coupling gear. For this purpose, a plurality of stiffnesses can also be used that are advantageously constructed as a helical compression spring which is formed of one part or also preferably formed of a plurality of parts nested radially one inside the other and so as to be virtually free of friction.

A second output stiffness can also be arranged in series with the first output stiffness in the torque transmission path between the output part of the coupling arrangement and the output region in a further advantageous embodiment form. As has already been mentioned, this serves to further reduce any output torsional vibrations which may be present.

In a further advantageous embodiment form, the planet wheel carrier comprises a carrier element and a supporting element connected to one another so as to be at least partially spaced apart from one another axially and so as to be fixed with respect to rotation relative to one another and that, as a result of the at least partial axial spacing, form an intermediate space in which the planet wheel element is rotatably mounted at the carrier element and the supporting element. The planet wheel element can be a stepped planet wheel or non-stepped planet wheel, which can also be constructed in a segmented manner. The planet wheel can advantageously be mounted so as to resist tilting by the bearing support of the planet wheel element at the carrier element on the one hand and at the supporting element on the other hand. In an advantageous embodiment form, the carrier element and the supporting element are continuously connected to one another in a radially inner region such that no viscous medium can penetrate. The connection can advantageously be carried out by a weld joint. In a radially outer region, the carrier element and the supporting element are likewise connected to one another, preferably by a weld joint. However, cutouts are in part located radially outside in the area of the bearing of the planet wheel element in order to control the planet wheel element by means of an input ring gear and an output ring gear.

A further advantageous embodiment form provides that the carrier element and the supporting element are shaped sheet metal elements. Shaped sheet metal parts offer the advantage that they can be produced inexpensively and quickly. Further, welded shaped sheet metal parts, for example, are highly stable, which is advantageous for the functioning of the torsional vibration damping arrangement overall.

In a further advantageous embodiment form, the first torque transmission path and/or the second torque transmission path and/or the torque transmission path between the output part of the coupling arrangement and the output region comprise(s) an additional mass. In this case also, the additional mass can serve to further reduce the torsional vibration. As has already been mentioned, the additional mass can be fastened at various places in the torsional vibration damping arrangement in order to achieve the best possible reduction of torsional vibrations. The positioning of the additional mass depends especially on the installation space and on the quality of the torsional vibration reduction to be achieved.

In a further advantageous constructional variant, the torsional vibration damping arrangement is enclosed by a housing element and there is a viscous medium inside the housing element. By arranging the torsional vibration damping arrangement in a wet space, which is filled with a viscous medium such as oil or grease, friction occurring in the torsional vibration damping arrangement can be reduced and the lifetime of the structural component parts can accordingly be prolonged. It is also advantageous because the structural component parts can be cooled with the viscous medium.

### BRIEF DESCRIPTION OF THE DRAWINGS

Preferred embodiment examples of the invention will be described in the following with reference to the accompanying drawings. In the drawings:

FIG. 1 is a schematic diagram showing a torsional vibration damping arrangement with three stiffnesses, one stiffness being arranged in the area of the planet wheel carrier;

FIG. 2 is a torsional vibration damping arrangement as described in FIG. 1 but structurally realized in cross section;

FIG. 3 is another cross section through a torsional vibration damping arrangement as described in FIG. 1;

FIG. 4 is a torsional vibration damping arrangement as described in FIG. 3 but in a front view;

FIG. 5 is a schematic diagram showing a torsional vibration damping arrangement as described in FIG. 1 but with two stiffnesses, one stiffness being arranged in the area of the planet wheel carrier;

FIG. 6 is a torsional vibration damping arrangement as described in FIG. 1 but with a simple planet wheel element instead of a stepped planet wheel element;

FIG. 7 is a torsional vibration damping arrangement as described in FIG. 2 but in cross section after the region of the planet wheel element;

FIG. 8 is a sealing plate for a torsional vibration damping arrangement as weight-optimized embodiment; and

FIG. 9 is a torsional vibration damping arrangement with possible additional stiffnesses.

### DETAILED DESCRIPTION OF THE PRESENTLY PREFERRED EMBODIMENTS

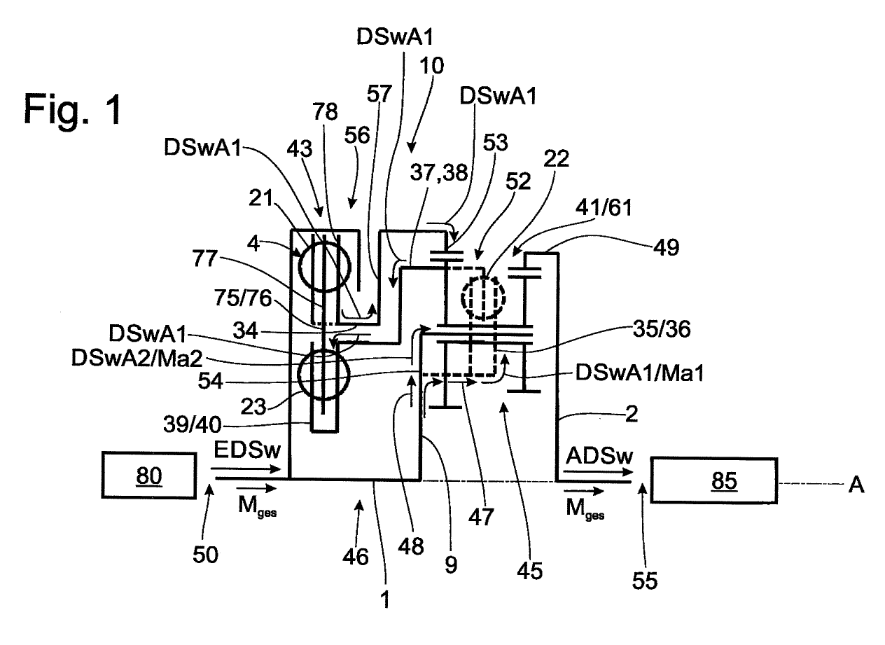

FIG. 1 is a schematic diagram showing a torsional vibration damping arrangement 10 operating on the principle of power splitting or torque splitting with a phase shifter arrangement 43 and a coupling arrangement 41, which may also be designated as a superposition unit 52. The torsional vibration damping arrangement 10 can be arranged in a powertrain of a vehicle, for example, between a drive unit 80, which in the present instance forms an input region 50 and the subsequent portion of the powertrain, i.e., for example, a gear unit 85 which in the present instance forms an output region 55. This input region 50 can be connected, for example, to a crankshaft in an internal combustion engine, neither of which is shown, so as to be fixed with respect to rotation relative to it. The torque path runs from the input region 50 to the output region 55 in the following manner: a torque coming from the input region 50, also designated as total torque Mges, is introduced into the torsional vibration damping arrangement 10, divided into a first torque component Ma1 and a second torque component Ma2 in that the first torque component Ma1 is further guided via a first torque transmission path 47 and the second torque component Ma2 is further guided via a second torque transmission path 48. Accordingly, an input torsional vibration EDSw that proceeds especially from the drive unit 80, for example, a reciprocating piston engine, not shown, is split into a first torsional vibration component DSwA1, which is guided via the first torque transmission path 47 and a second torsional vibration component DSwA2 that runs via the second torque transmission path 48. The first torque transmission path 47 includes a phase shifter arrangement 43, which in the present instance comprises three stiffnesses, more precisely, a first stiffness 21, a second stiffness 22 and an additional stiffness 23. The three stiffnesses are preferably formed from helical springs. In this embodiment according to the invention, the second stiffness 22 is positioned in the area of the coupling arrangement 41. This can be carried out advantageously because, in an advantageous arrangement, the coupling arrangement 41 comprises three planet wheel elements 45 distributed symmetrically along the circumference. The stiffness, in this instance the second stiffness 22, can be positioned in a space-saving manner within an intermediate space which is accordingly formed between two adjacent planet wheel elements. The second stiffness 22 is arranged so as to be partially radially overlapping and partially axially overlapping with respect to the coupling arrangement 41. The torque path of the first torque component Ma1 and accordingly also the path of the first torsional vibration component DSwA1 in the first torque transmission path 47 runs from the input region 50 via an input element 35, which can also be constructed as a covering plate 42, to the second stiffness 22. The first torque component Ma1 with the first torsional vibration component DSwA1 is guided from the second stiffness 22 by an output element 37, which can also be constructed as a hub disk 38, to an input element 39 which is connected thereto so as to be fixed with respect to rotation relative to it and which can also be constructed as a covering plate 42, and further to the additional stiffness 23. The first torque component Ma1 and the first torsional vibration component DSwA1 arrive at the first stiffness 21 from the additional stiffness 23 by an output element 75, which is constructed in the present instance as a hub disk 76. The hub disk 76 also serves as control element 77 for the first stiffness 21. By an output element 34 of the first stiffness 21 to a first input part 53 of the coupling arrangement 41. The first input part 53 of the coupling arrangement 41 is connected to the output element 34 of the first stiffness 21 so as to be fixed with respect to rotation relative to it.

In the second torque transmission path 48, the second torque component Ma2 with the second torsional vibration component DSwA2 is guided from the input region 50 directly to the planet wheel carrier 9 of the coupling arrangement 41, the planet wheel carrier 9 representing the second input part 54 in this instance. Consequently, the first torque component Ma1 and the second torque component Ma2 and the first torsional vibration component DSwA1, which is now shifted in phase, and the second torsional vibration component DSwA2 are guided together again at the coupling arrangement 41 to form a total output torque Maus and an output torsional vibration ADSw or, more precisely, torsional vibration components 1 and 2 are destructively superimposed at the coupling arrangement. The aim of the destructive superposition is to minimize, optimally even to completely eliminate, the output torsional vibration ADSw compared to the input torsional vibrations EDSw so that there is no longer any torsional vibration at the output region 55.

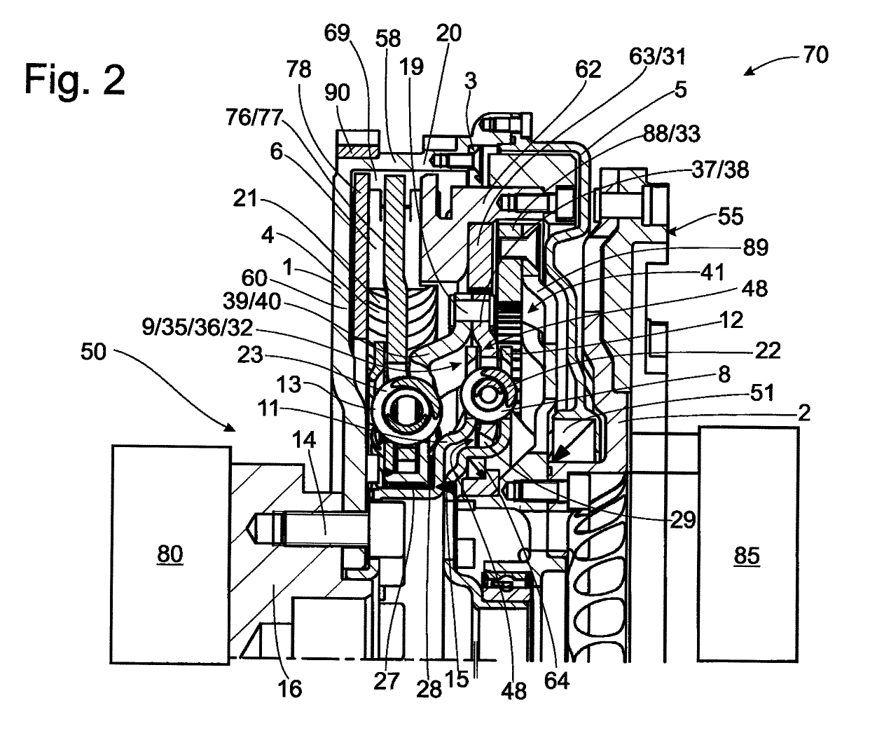

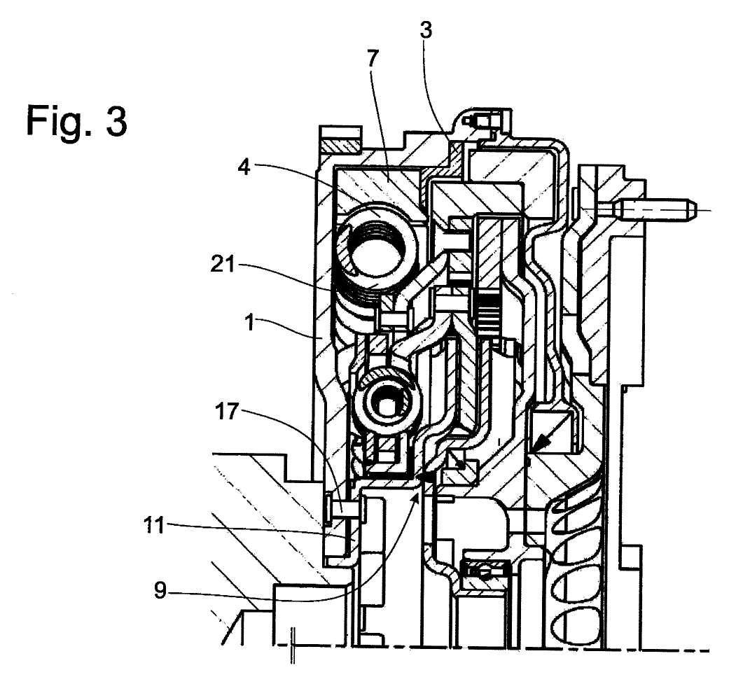

FIGS. 2 and 3 show a torsional vibration damping arrangement 10 as in FIG. 1 described as schematic layout, but structurally realized in cross section. For the sake of clarity, the construction will be described referring to FIG. 2 and the torque path and the torsional vibration path will be described referring to FIG. 3. The torque path Mges and therefore also the path of the input torsional vibrations EDSw runs from the input region 50 to the output region 55 as was shown referring to FIG. 1. This torque transmission path, which also forms the transmission path for the input torsional vibration EDSw, will be described more fully in the following. But the construction of the torsional vibration damping arrangement 10 will be addressed first.

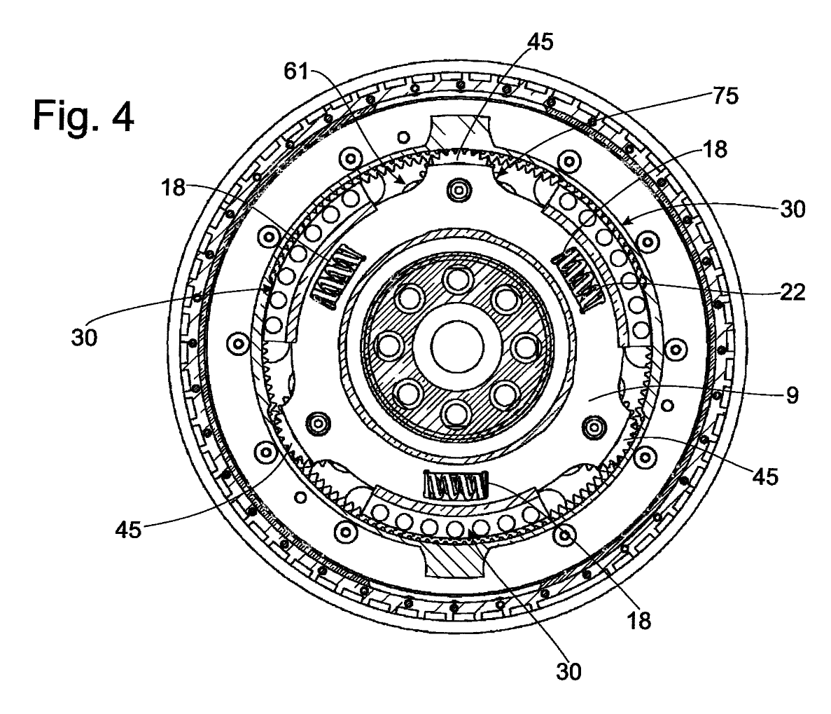

The input region 50 of the torsional vibration damping arrangement 10 is formed in this instance by a crankshaft 16 of the drive unit 80, for example, a reciprocating piston engine, not shown. A primary mass 1 is connected by a screw joint 14 to the crankshaft 16 so as to be fixed with respect to rotation relative to it. The primary mass 1 is connected on the radially outer side to a cover plate 3 and a sealing plate 5 so as to be fixed with respect to relative rotation. These structural component parts 1; 3; and 5, together with the planet wheel carrier 9 which here comprises a carrier element 11 and a supporting element 12 spaced apart from one another axially, constitute a primary side of the torsional vibration damping arrangement 10. The carrier element 11 of the planet wheel carrier 9 is connected by a rivet fastening 17, shown in FIG. 3, to the primary mass 1 so as to be fixed with respect to rotation relative to it. However, a different fastening method such as screwing, for example, can also be selected. The carrier element 11 and the supporting element 12 of the planet wheel carrier 9 are connected to one another by a weld seam 15 so as to be fixed with respect to relative rotation radially inwardly circumferentially and so as to be impermeable to a viscous medium. However, another, equivalent connection can also be selected for this purpose. The opening area 29 formed by the axial spacing between the carrier element 11 and the supporting element 12 receives the spring arrangement 8 of the second stiffness 22. The spring arrangement 8 is arranged in one part or, as is shown here, in a plurality of parts nested radially one inside the other and virtually free of friction at the circumference between the planet wheel elements 45; 45a; 45b in a spring window 18, which is shown more clearly in FIG. 4. This can be carried out in an advantageous manner because, in advantageous construction, the coupling arrangement 41 comprises three planet wheel elements 45, 45a, 45b, which are distributed symmetrically along the circumference as is shown more clearly in FIG. 4. The stiffness, in this case the second stiffness 22, can be positioned in a space-saving manner inside an intermediate space 30, which is accordingly formed between two adjacent planet wheel elements 45. The second stiffness 22 is arranged so as to be partially radially overlapping and partially axially overlapping with respect to the coupling arrangement 41. The additional stiffness 23 is arranged downstream of the second stiffness 22, and the latter are connected to one another through a control element 40 forming an input element 39 for the additional stiffness 23. The control element 40 is mounted at the carrier element 11 radially and axially by a radial bearing 27 and an axial bearing 28. Mounted downstream of this additional stiffness 23 is a first stiffness 21 that is axially overlapping and radially staggered with respect to the additional stiffness 23 in a space-saving manner. The first stiffness 21 is connected to the additional stiffness 23 by a control element 77. The first stiffness 21, the additional stiffness 23 and the second stiffness 22 are constructed in this instance as spring arrangements 8, 12 and 4 which, in this instance, are formed of multiple parts and nested radially one inside the other. In this instance, the spring arrangement 4 of the first stiffness 21 is mounted by a spring disk 6 and a sliding block 7, shown in FIG. 3, in a friction-minimizing manner at a housing element 20 formed from the primary mass in this case and also receives a starter ring gear 90. Further, the first stiffness 21 is connected to an input ring gear carrier 62 so as to be fixed with respect to rotation relative to it, which input ring gear carrier 62 is in turn connected to an input ring gear 63 so as to be fixed with respect to rotation relative to it. In this instance, the input ring gear 63 forms a first input element 31 of the coupling arrangement 41. The planet wheel carrier 9 connected by a screw joint 14 to a crankshaft 16 of a drive unit 80 so as to be fixed with respect to relative rotation forms the second input element 32 of the coupling arrangement 41. An output ring gear 88 forms the output element 33 of the coupling arrangement and is connected by an output ring gear carrier 89 to the output region 55 so as to be fixed with respect to rotation relative to it. In this regard, the output region 55 can be connected, for example, to a shiftable clutch element, not shown, which is connected in turn to a downstream gear unit 85.

In order that a wet space 69, which is preferably provided with a viscous medium such as oil or grease, is sealed relative to a surrounding area 70, a sealing element 51 is installed between the covering plate 42 and the secondary mass 2 of the output region 55 and a sealing element 64 is installed between the output ring gear carrier 89 and the supporting ring 12 of the planet wheel carrier 9. Sealing element 51 and sealing element 64 are preferably constructed as radial shaft sealing rings. The output ring gear carrier 89 is mounted by a bearing element 74 at an extension area of the supporting ring 12 of the planet wheel carrier 9 in a radially inner region around the axis of rotation A. A radially inner region of the extension area of the supporting ring 12 can in turn also receive a bearing, not shown, which can be used as a type of pilot bearing for a transmission input shaft.

The path of the total torque Mges and, therefore, also of the input torsional vibration EDSw runs from the input region 50 to the output region 55 in a manner described in the following.

The total torque Mges and the input torsional vibration EDSw, which are introduced into the torsional vibration damping arrangement 10 proceeding from the input region 50, are split into the first torque component Ma1 and the second torque component Ma2 in that the first torque component Ma1 is further guided via the first torque transmission path 47 and the second torque component Ma2 is further guided via the second torque transmission path 48. Accordingly, the input torsional vibration EDSw, which proceeds especially from the drive unit 80, for example, from the reciprocating piston engine, not shown, is also split into the first torsional vibration component DSwA1, which is guided via the first torque transmission path 47 and into the second torsional vibration component DSwA2, which is guided via the second torque transmission path 48. The first torque transmission path 47 includes the phase shifter arrangement 43 which, in this instance, comprises three stiffnesses, more precisely, a first stiffness 21, a second stiffness 22 and an additional stiffness 23. The three stiffnesses 21; 22; 23 are preferably formed from helical springs which, in this instance, are preferably constructed of multiple parts nested radially one inside the other. In this embodiment according to the invention, as has already been mentioned, the second stiffness 22 is positioned in the area of the coupling arrangement 41 in a space-saving manner. The first torque component Ma1 and, therefore, also the first torsional vibration component DSwA1 in the first torque transmission path 47 runs from the crankshaft 16 via an input element 35 that is formed in this instance by the planet wheel carrier 9, more precisely, through the carrier element 11 and the supporting element 12. The carrier element 11 and the supporting element also form a control element 36 for the spring arrangement 8 of the second stiffness 22. The first torque component Ma1 and the first torsional vibration component DSwA1 arrive at an input element 39 of the additional stiffness 23 from the spring arrangement 8 by an output element 37 constructed in this instance as a hub disk 38, which input element 39 is connected to the output element 37 so as to be fixed with respect to rotation relative to it. The hub disk 38 and the input element 39 are connected to one another so as to be fixed with respect to relative rotation at their radially outer area by a rivet connection 19. The input element 39 forms a control element 40 for the spring arrangement 13 of the additional stiffness 23. The control element 40 is supported at the carrier element 11 of the planet wheel carrier 9 radially and axially by a radial bearing 27, constructed in this instance as a sliding bearing, and an axial bearing 28 constructed in this instance as a sliding bearing. The first torque component Ma1 and the first torsional vibration component DSwA1 are further guided from spring arrangement 13 to spring arrangement 4 of the first stiffness 21 by a hub disk 76. The hub disk 76 serves in this instance as a control element 77 for the spring arrangement 4 of the first stiffness. Further, spring arrangement 4 is advantageously radially supported at a circumferential edge region 58 of the primary mass 1 in a friction-minimizing manner by a spring disk 6 and a sliding block 7. An axial bearing support or, better, an axial securing is carried out through the cover plate 3 on the one hand and through a lateral surface 60 of the primary mass 1 on the other hand. In this case, the first stiffness 21 is advantageously arranged so as to axially overlap and so as to be radially staggered with respect to the additional stiffness 23 in a space saving manner. The first torque component Ma1 and the first torsional vibration component DSwA1 arrive at an input ring gear 63 from the spring arrangement 4 of the first stiffness 21 by the output element 78 connected to an input ring gear carrier 62 so as to be fixed with respect to rotation relative to it, this input ring gear 63 being connected to the input ring gear carrier 62 so as to be fixed with respect to rotation relative to it. The input ring gear meshes with the planet wheel element 45 and consequently guides the first torque component Ma1 and the first torsional vibration component DSwA1 to the coupling arrangement 41 so as to be out of phase with the second torque component Ma2 and the second torsional vibration component DSwA2 by reason of the three stiffnesses 21; 22; 23.

In the second torque transmission path 48, the second torque component Ma2 with the second torsional vibration component DSwA2 is guided from the crankshaft 16 directly to the planet wheel carrier 9 of the coupling arrangement 41, which planet wheel carrier 9 is connected to the crankshaft 16 so as to be fixed with respect to rotation relative to it.

Consequently, the second torque component Ma2 and the second torsional vibration component DSwA2 are superimposed at the coupling arrangement 41 with the phase-shifted first torque component Ma1 and the first torsional vibration component DSwA1, which is likewise shifted in phase, such that a destructive superposition of the torsional vibration components DSwA1 and DSwA2 comes about in the coupling arrangement. This is the case when the vibration system 56 of the phase shifter arrangement 43 is operated above a limiting speed at which the vibration system is in a resonant operation, also be referred to as supercritical operating range, and the coupling arrangement 41 is configured such that an output torsional vibration ADSw with vibration components which are minimized relative to the input torsional vibration EDSw results from the superposition of the first torsional vibration component DSwA1 with the second torsional vibration component DSwA2.

To this end, the coupling arrangement is configured such that the first torsional vibration component DSwA1 is superimposed with second torsional vibration component DSwA2 which is oppositely directed for the output element 33.

The aim of the destructive superposition consists in the output torque Maus, which is guided from the coupling arrangement 41 to the output region 55, formed in this instance by the gear unit 85, by an output ring gear 88 and an output ring gear carrier 89, which is connected to the latter so as to be fixed with respect to rotation relative to it, and which output torque Maus also contains the output torsional vibrations ADSw which are minimized compared to the input torsional vibrations EDSw and are optimally even entirely eliminated. The torque components Ma1; Ma2 in turn add up to an output torque Maus.

FIG. 3 shows a torsional vibration damping arrangement 10 as described in FIG. 1, but with a different cross section. As has already been mentioned referring to FIG. 2, the sliding block 7 which can be seen particularly clearly in FIG. 3 supports the spring arrangement 4 of the first stiffness 21 radially outwardly at the edge region 58 of the housing element 20 formed by the primary mass 1. This is particularly advantageous when the spring arrangement 4 is pressed radially outward under centrifugal force that would cause increased friction and could negatively impact a damping behavior of the spring arrangement. The sliding block is supported in axial direction by the primary mass 1 on the one hand and by the cover plate 3 on the other hand. Further, it is shown here that the carrier element 11 of the planet wheel carrier 9 is connected by a rivet fastening 17 to the primary mass 1 so as to be fixed with respect to rotation relative to the latter.

FIG. 4 shows a torsional vibration damping arrangement 10 as described in FIG. 3 but in a front view. The arrangement of the second stiffness 22 inside the planetary gear unit 61, already described referring to FIG. 1, can be seen clearly. The spring arrangement 8 of the second stiffness 22 is positioned in a space-saving manner in the intermediate spaces 30 between the planet wheel elements 35. Since the planetary gear unit 61 comprises three planet wheel elements 45 in this instance, three intermediate spaces 30 are also formed, within which the three spring arrangements 8 of the second stiffness 22 can be installed uniformly with a pitch angle of 120°. An even smaller axial installation width can be achieved by spring windows 18 that are arranged at the planet wheel carrier 9 and through which the spring arrangements 8 can at least partially axially overlap with the planet wheel carrier 9.

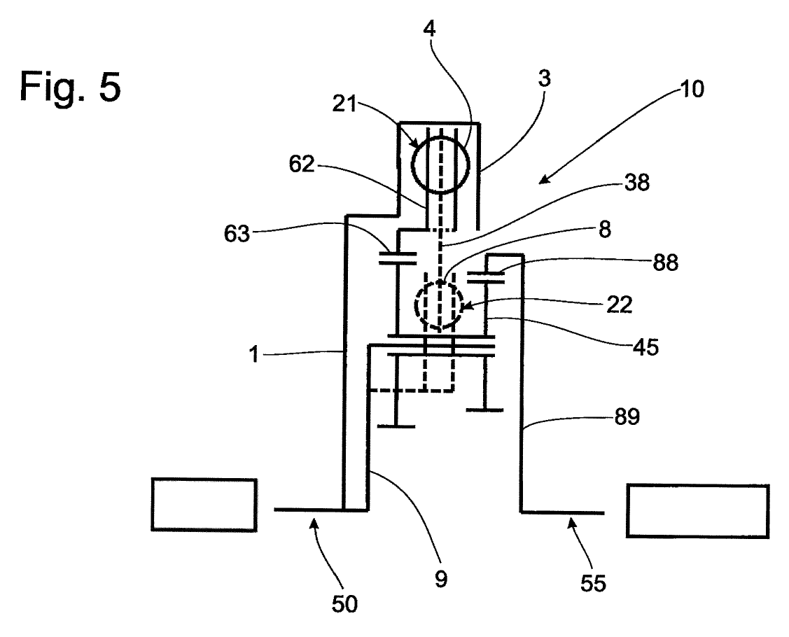

FIG. 5 is a schematic diagram showing a torsional vibration damping arrangement 10 as described in FIGS. 1 and 2, but with two stiffnesses, wherein one stiffness is arranged in the area of the planet wheel carrier.

The primary mass 1 is connected by the cover plate 3 to the input region 50 so as to be fixed with respect to rotation relative to it. Together with the planet wheel carrier 9, these components constitute a primary side of the torsional vibration damping arrangement 10. Connected to the planet wheel carrier 9 is the second stiffness 22 whose spring arrangement 8 is arranged at the circumference between the planet wheel elements 45, this spring arrangement 8 being constructed in one part or preferably in a plurality of parts nested radially one inside the other so as to be virtually free of friction. The spring arrangement 8 of the second stiffness 22 is connected in this instance by a hub disk 38 to the spring arrangement 4 of the first stiffness, which in turn can likewise be constructed of one part or preferably of a plurality of parts radially nested one inside the other. The spring arrangement 4 is further connected to an input ring gear 63 by an input ring gear carrier 62 connected so as to be fixed with respect to relative rotation, this input ring gear 63 meshing with the planet wheel element 45 which is stepped in this instance. An output ring gear 88 meshes with the stepped planet wheel element 45 and is connected to the output region 55 via an output ring gear carrier 89. The torque transmission path Mges and the transmission of the input torsional vibration EDSw from the input region 50 to the output region 55 run as already described referring to FIGS. 2 and 3, although in this instance there are only two stiffnesses 21 and 22.

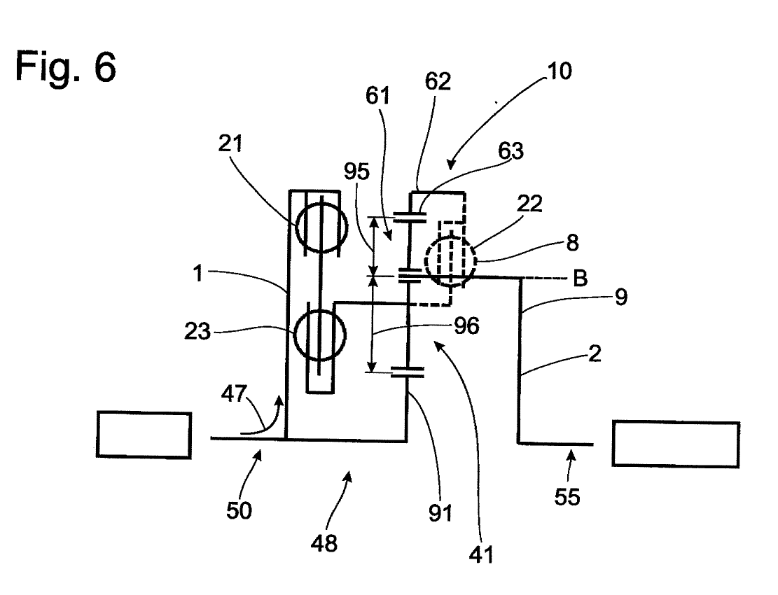

FIG. 6 shows a torsional vibration damping arrangement 10, also as described referring to FIG. 1, with three stiffnesses 21, 23, 22; but the output region 55 is connected to the planet wheel carrier 9 of the planetary gear unit 61 so as to be fixed with respect to rotation relative to it, and the second torque transmission path 48 is connected to the planetary gear unit by a sunwheel 91. In this connection, a path of the total torque Mges and of the input torsional vibration EDSw runs from the input region 50 to the output region 55 as follows: The total torque Mges and the input torsional vibration EDSw are divided between the first torque transmission path 47 and the second torque transmission path 48. In so doing, the second torque transmission path is directly connected to the coupling arrangement 41 by the sunwheel 91 that meshes with planet wheel element 45 and accordingly guides the second torque component Ma2 and the second torsional vibration component DSwA2 directly to the coupling arrangement. The first torque component Ma1 and the first torsional vibration component DSwA1 are guided via the first torque transmission path 47 to the coupling arrangement 41 by the input ring gear carrier 62 and the input ring gear 63, which is connected to the latter so as to be fixed with respect to rotation relative to it. The three stiffnesses 21, 23 and 22 are situated in the first torque transmission path. It should be noted here that in this constructional variant, viewed from the input region 50, the first stiffness 21 is initially controlled by the primary mass 1, which is connected to the input region 50 so as to be fixed with respect to rotation relative to it. The additional stiffness 23 and then subsequently the second stiffness 22, which is likewise arranged so as to be axially overlapping with respect to the planet wheel element 45 are controlled by the first stiffness 21. A maximum twist angle of the primary mass 1 relative to the planet wheel carrier 9 can be increased through the use of a plurality of stiffnesses such as in this instance three stiffnesses 21, 23, 22.

It is necessary that the spring arrangement 8 arranged in the planet wheel carrier 9 is controlled last in the torque flow considered from the primary mass 1 because the relative twist angle of the components in the planet wheel carrier 9 is limited by the arrangement of the planet wheel elements 45, and the planet wheel carrier 9 constitutes the secondary mass 2 in this case. For this reason, at least one substantially softer spring arrangement 21 or 23, which can exhibit appreciably more twist angle must also be arranged upstream. Owing to the constructional form of the coupling gear 41 with input ring gear 63 and sunwheel 91, this coupling gear 41 can be constructed so as to be axially narrower than the constructional variants with two ring gears. In order to reduce radial installation space, the planet wheel elements 45 can be provided with different effective radii 95, 96 proceeding from the planet axis B for the respective contact of input ring gear 63 and sunwheel 91.

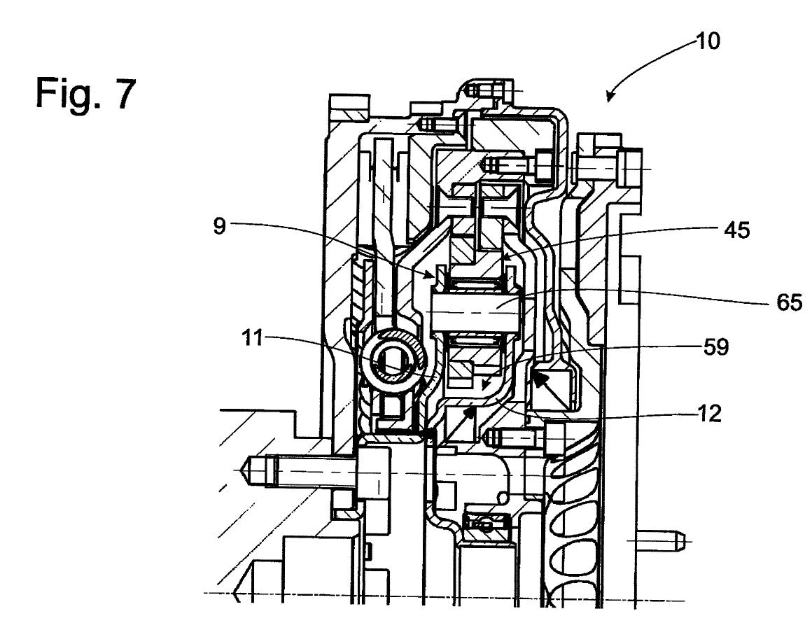

FIG. 7 shows a torsional vibration damping arrangement 10 as described in FIG. 2, but in cross section in the region of a planet wheel pin 65. Considered advantageous here is the configuration of the planet wheel carrier 9 comprising the carrier element 11 and the supporting element 12, which are spaced apart axially to form an intermediate space 59 in which the planet wheel element 45 can be received. Through the use of the supporting ring 12, the planet wheel pin 65 can be supported at both sides, namely, at the carrier element 11 on one side and at the supporting ring 12 on the other side, which has positive consequences for the overall stiffness of the planet wheel carrier 9 and, therefore, also has a positive result on a decoupling quality of the torsional vibration damping arrangement 10 in its entirety.

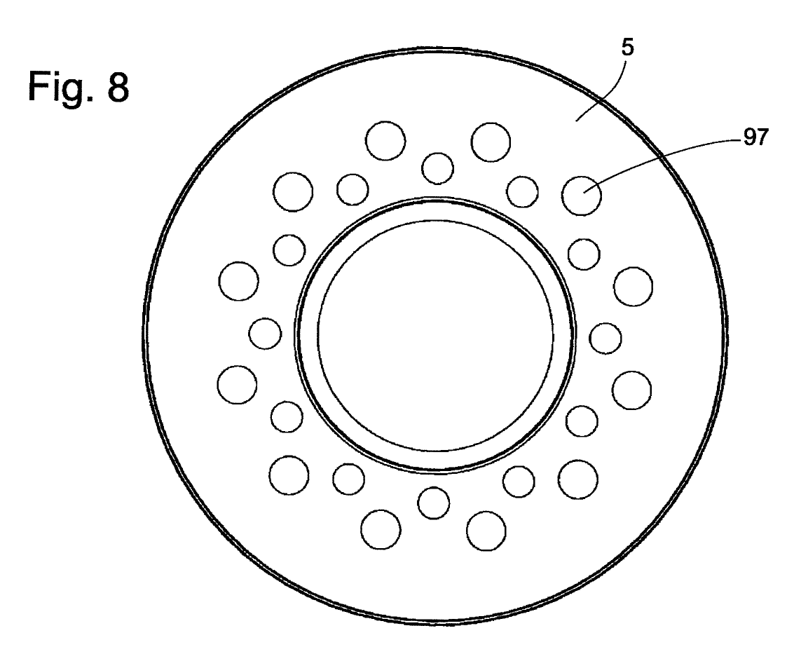

FIG. 8 shows a sealing plate 5 for a torsional vibration damping arrangement 10, such as was already described referring to FIG. 2, in a weight-optimized construction. The sealing plate 5 is typically produced such that it has a uniform wall thickness with a constant density. This sealing plate 5 can be optimized with respect to weight by the lightening areas 97 shown in the radially inner region of the sealing plate 5 without experiencing large losses of a mass moment of inertia of the sealing plate 5. The lightening areas 97 must always be constructed tightly to prevent an escape of lubricant from the torsional vibration damping arrangement. In a preferred configuration, they are uniformly distributed along the circumference so that an unbalance of the sealing plate 5 is prevented as far as possible.

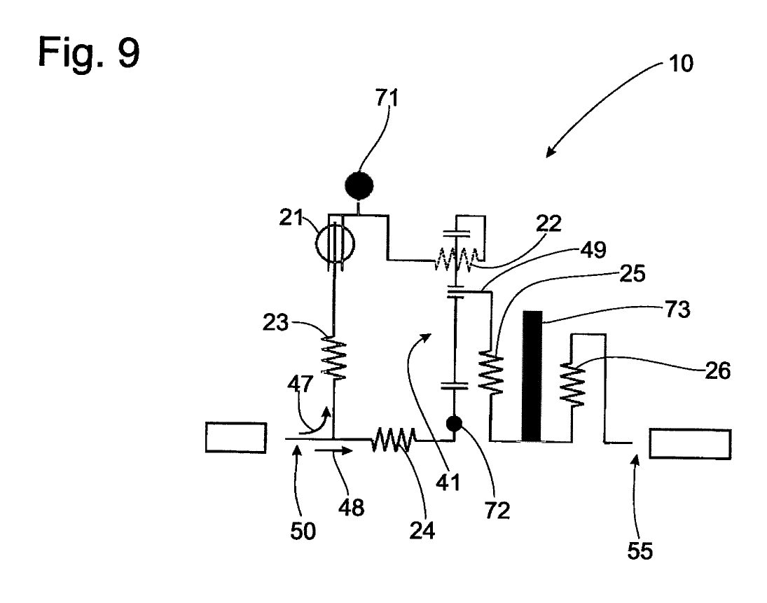

FIG. 9 shows a torsional vibration damping arrangement 10 at which possible additional stiffnesses can be installed in order to optimize qualitatively the decoupling of torsional vibrations. In addition to stiffnesses 21, 22, 23, already known, which can be installed in the first torque transmission path 47, one or more additional stiffnesses 24 can also be installed in the second torque transmission path 48. One or more additional stiffnesses, as in this case output stiffnesses 25, 26, can also be installed in the region of the output part 49 of coupling arrangement 41. It can also be advantageous to arrange additional masses 71, 72, 73 at the torque transmission paths 47, 48 in order to improve the decoupling quality. Additional masses can advantageously be arranged in the first torque transmission path 47, in the second torque transmission path 48 and at the output part 49 of the coupling arrangement 41. These additional masses 71, 72, 73 can advantageously be formed as simple mass elements, pendulum masses, damper masses or the like known inertia masses. The locations described in FIG. 9 are to be considered exemplary. Additional masses and additional stiffnesses can be combined in any way.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-44. (canceled)

15. A torsional vibration damping arrangement, comprising:
an input region comprising a primary mass and configured to be driven in rotation around an axis of rotation;
an output region comprising a secondary mass;
a coupling arrangement communicating with the output region and which comprises:
a first input element;
a second input element; and
an output element, and
a torque transmission path configured to transmit a total torque (Mges), which torque transmission path extends between the input region and the output region,
wherein the torque transmission path from the input region to the coupling arrangement comprises:
a first torque transmission path for transmitting a first torque component (Ma1) comprises:
a phase shifter arrangement comprising a vibration system with a first stiffness, wherein the first stiffness comprises a spring arrangement and a second stiffness that is supported relative to the primary mass and is arranged so as to be at least partially axially and radially overlapping with respect to the coupling arrangement; and
a second torque transmission path for transmitting a second torque component (Ma2) that is parallel to the first torque transmission path;
wherein the first torque transmission path, the second torque transmission path and, therefore, the first torque component (Ma1) and the second torque component (Ma2) are guided together again at the coupling arrangement to form an output torque (Maus);
wherein an input torsional vibration (EDSw) proceeding from the input region is divided into a first torsional vibration component (DSwA1) and a second torsional vibration component (DSwA2) by being guided via the first torque transmission path and via the second torque transmission path, and
wherein during an operation of the vibration system in a speed range above at least one limit speed at which the vibration system is operated in a resonant range, the first torsional vibration component (DSwA1) is superimposed with the second torsional vibration component (DSwA2) at the coupling arrangement such that the first torsional vibration component (DSwA1) and the second torsional vibration component (DSwA2) are destructively superimposed, and an output torsional vibration (ADSw) which is minimized relative to the input torsional vibration (EDSw) is present at the output element of the coupling arrangement.

16. The torsional vibration damping arrangement according to claim 15, wherein the coupling arrangement comprises:
a planetary gear unit with a planet wheel carrier;
a planet wheel pin fastened to the planet wheel carrier; and
a planet wheel element rotatably supported at the planet wheel pin,
wherein the planet wheel element is connected to the input region by the first input element and by the second input element, and
wherein the planet wheel element is connected to the output region by the output element.

17. The torsional vibration damping arrangement according to claim 15, wherein the phase shifter arrangement comprises:
a vibration system with the primary mass; and
an intermediate element rotatable with respect to the primary mass around the axis of rotation against an action of a spring arrangement.

18. The torsional vibration damping arrangement according to claim 17, wherein the second stiffness is supported on an other side relative to the intermediate element.

19. The torsional vibration damping arrangement according to claim 15, wherein the phase shifter arrangement comprises an additional stiffness arranged to be at least partially axially overlapping with respect to the first stiffness.

20. The torsional vibration damping arrangement according to claim 15, wherein the first stiffness and the second stiffness of the phase shifter arrangement are arranged in series.

21. The torsional vibration damping arrangement according to claim 19, wherein the first stiffness, the second stiffness, and the additional stiffness of the phase shifter arrangement are arranged in series.

22. The torsional vibration damping arrangement according to claim 15, wherein the second torque transmission path between the input region and the second input element of the coupling arrangement comprises an additional stiffness.

23. The torsional vibration damping arrangement according to claim 15, wherein the torque transmission path between an output part of the coupling arrangement and the output region comprises at least one first output stiffness.

24. The torsional vibration damping arrangement according to claim 23, wherein a second output stiffness is arranged in series with the first output stiffness in the torque transmission path between the output part of the coupling arrangement and the output region.

25. The torsional vibration damping arrangement according to claim 16, wherein the planet wheel carrier comprises:
a carrier element and a supporting element connected to one another to be at least partially spaced apart from one another axially and to be fixed with respect to rotation relative to one another and which, as a result of the at least partial axial spacing, form an intermediate space in which the planet wheel element is rotatably mounted at the carrier element and the supporting element.

26. The torsional vibration damping arrangement according to claim 25, wherein the carrier element and the supporting element are shaped sheet metal elements.

27. The torsional vibration damping arrangement according to claim 23, wherein at least one of the first torque transmission path, the second torque transmission path, and the torque transmission path between the output part of the coupling arrangement and the output region comprises an additional mass.

28. The torsional vibration damping arrangement according to claim 15, wherein the torsional vibration damping arrangement is enclosed by a housing element, and a viscous medium is located inside the housing element at least in part.
